(19) United States
(12) Patent Application Publication
(10) Pub. No.: US 2011/0261915 A1
(43) Pub. Date: Oct. 27, 2011

(54) System and method for self-correcting the multiphase clock

(75) Inventor: Bin Li, Chengdu (CN)

(73) Assignee: IPGoal Microelectronics (SiChuan) Co., Ltd.

(21) Appl. No.: 13/091,027

(22) Filed: Apr. 20, 2011

(30) Foreign Application Priority Data
Apr. 21, 2010 (CN) 201010153834.8

(51) Int. Cl. H04L 7/02

(52) U.S. Cl. 375/359

(57) ABSTRACT

A system for self-correcting the multiphase clock includes a transmitter, a receiver, a random code generator and a controller. The random code generator generates a random code stream, the random code stream is transformed to the high-speed serial data by the transmitter, the high-speed serial data are sent into the receiver and transformed to the parallel data by the receiver, the parallel data are sent into the controller, the controller stores the random code stream and detects the probability of the bit error of the parallel data output by the receiver. According to the test result of the bit error, the controller generates a phase adjustment control signal for adjusting the phase uniformity of the multiphase clock. Also, a method for self-correcting the phase uniformity of the multiphase clock of the present invention effectively makes up the sampling bit errors caused by the phase nonuniformity of the multiphase clock.

### BACKGROUND OF THE PRESENT INVENTION

1. Field of Invention

The present invention relates to a sampling system of high-speed data multiphase clock, and more particularly to a system and method for self-correcting the multiphase clock.

2. Description of Related Arts

In the high-speed interface system, the multiphase clock is usually generated by the phase-locked loop (PLL) or delay-locked loop (DLL), and the received high-speed data are recovered by over-sampling.

The phase uniformity of the multiphase clock determines the size of the over-sampling window to some extent. Accordingly, the phase nonuniformity of the multiphase clock affects the accuracy of the sampling data, so that the bit errors occur in the received data, which greatly affects the performance of the high-speed interface.

### SUMMARY OF THE PRESENT INVENTION

An object of the present invention is to provide a system for self-correcting the multiphase clock, wherein the corrected clock has the phase uniformity.

Accordingly, in order to accomplish the above object, the present invention provides a system for self-correcting the multiphase clock, comprising:

a transmitter;

a receiver connected with the transmitter;

a random code generator connected with the transmitter; and

a controller connecting with the random code generator and the receiver,

wherein the random code generator generates a random code stream, the random code stream is transformed to high-speed serial data by the transmitter, the high-speed serial data are sent into the receiver and are transformed to parallel data by the receiver, the parallel data are sent into the controller, the controller stores the random code stream, detects a probability of a bit error of the parallel data output by the receiver, and generates a phase adjustment control signal for adjusting a phase uniformity of the multiphase clock according to a test result of the bit error.

Also, the present invention provides a method for self-correcting a phase uniformity of a multiphase clock, comprising the steps of:

(1) selecting a clock of the multiphase clock;

(2) adjusting a phase of the clock along a direction of phase lead;

(3) judging whether a bit error of parallel data output by a receiver occurs through a controller, wherein if it doesn't occur, continue adjusting the phase along the same direction till the bit error occurs, record an adjusted value of the current phase lead and go into the next step; if it occurs, record an adjusted value of the current phase lead and go into the next step;

(4) adjusting a phase of the clock along a direction of phase lag;

(5) judging whether a bit error of parallel data output by a receiver occurs through a controller, wherein if it doesn't occur, continue adjusting the phase along the same direction till the bit error occurs, record an adjusted value of the current phase lag and go into the next step; if it occur, record an adjusted value of the current phase lag and go into the next step; and

(6) taking an intermediate value of the adjusted value of the phase lead and the adjusted value of the phase lag as an adjustment control code of the clock, trimming and outputting the clock.

Compared with the prior art, the present invention uses the internal self-loopback of the random code, and self-corrects the phase of every clock of the multiphase clock by judging whether the bit error of the parallel data output by the receiver occurs, such that the corrected phase of the multiphase clock is uniform and reaches the best sampling window, thus effectively making up the sampling bit errors caused by the phase nonuniformity of the multiphase clock during the manufacturing process or signal transmission process.

These and other objectives, features, and advantages of the present invention will become apparent from the following detailed description, the accompanying drawings, and the appended claims.

### BRIEF DESCRIPTION OF THE DRAWINGS

FIG. 1 is a structural diagram of a system for self-correcting the multiphase clock according to a preferred embodiment of the present invention.

FIG. 2 is a flow chart of a method for self-correcting the phase uniformity of the multiphase clock according to a preferred embodiment of the present invention.

### DETAILED DESCRIPTION OF THE PREFERRED EMBODIMENT

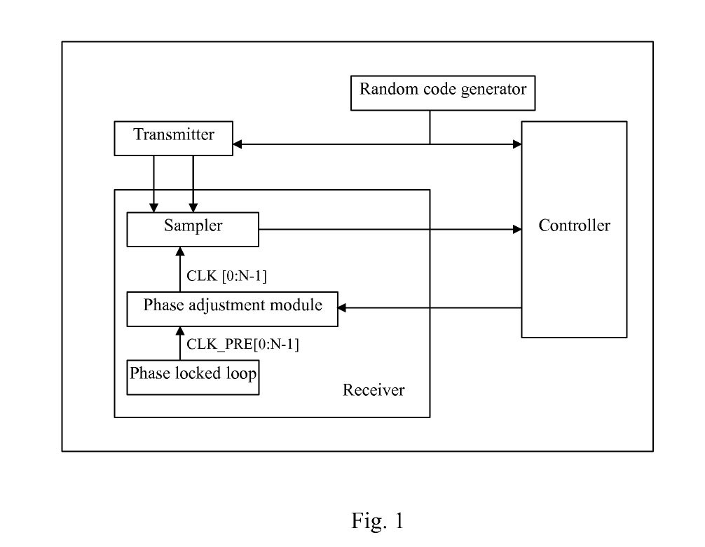

Referring to FIG. 1 of the drawings, a system for self-correcting the multiphase clock according to a preferred embodiment of the present invention is illustrated, wherein the self-correcting system comprises a random code generator, a transmitter connecting with the random code generator, a receiver connecting with the transmitter, and a controller connecting with the random code generator and the receiver.

The random code generator is adapted for generating the random code stream, and then the random code stream is transformed to the high-speed serial data by the receiver, and then the high-speed serial data are sent into the receiver. The receiver comprises a phase locked loop (PLL), a phase adjustment module connecting with the phase locked loop, and a sampler connecting with the phase adjustment module. The phase locked loop is adapted for generating the multiphase clock CLK_PRE[0:N-1]. The multiphase clock CLK_PRE[0:N-1] passes through the phase adjustment module, thus obtaining the multiphase clock CLK[0:N-1]. The multiphase clock CLK[0:N-1] acts on the sampler, and then the high-speed serial data are transformed to the parallel data by oversampling and then transmitted to the controller. The random code stream generated by the random code generator is stored within the controller, and simultaneously, the parallel data output by the receiver are received by the controller, and the probability of the bit error of the parallel data output by the receiver is detected by the controller. According to the test result of the bit error, the controller generates a phase adjustment control signal for controlling the phase adjustment module to adjust the phase uniformity of the multiphase clock CLK[0:N-1] relative to the data sampling, so as to obtain the optimal sampling window. Here, the phase locked loop can be a delay-locked loop.

The specific adjustment is described as follows. When no bit error exists, only the phase of a clock of the multiphase clock CLK[0:N-1] is changed every time and is slightly adjusted along the direction of the phase lead (or the phase lag) till the bit error occurs, and then the phase of the clock is slightly adjusted along the direction of the phase lag (or the phase lead) till the bit error occurs again. Define the intermediate value of the adjustment step sizes while the bit error occurs twice as the phase control code of the clock. According to the phase control code, the phase adjustment module adjusts the phase of the clock such that the clock has the best sampling phase relative to the data. Under the condition that no bit error exists, the phase of the next clock adjacent to the adjusted clock will be changed, the best sampling phase relative to the data of the corresponding next clock is determined in the same way. Repeat the above steps till the corresponding best sampling phase of every clock of the multiphase clock CLK[0:N-1] is adjusted. Therefore, the self-correcting of the multiphase clock is completed.

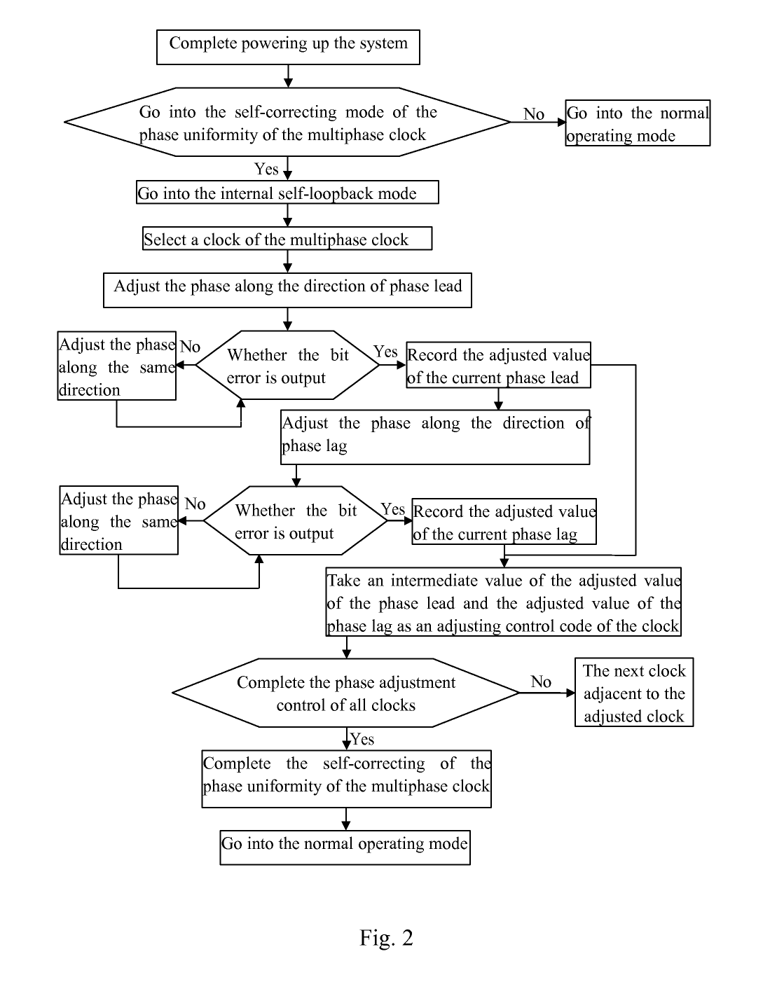

Referring to FIG. 2, a method for self-correcting the phase uniformity of the multiphase clock according to the preferred embodiment of the present invention comprises the steps as below.

(1) Complete powering up the high-speed interface system;

(2) Judge whether go into the self-correcting mode of the phase uniformity of the multiphase clock as required, if it does, go into the next step; if it doesn't, go into the normal operating mode.

(3) The system goes into the internal self-loopback mode. The random code generator generates the random code stream, and then the random code stream is transformed to the high-speed serial data by the transmitter, and then the high-speed serial data are sent into the receiver. The probability of the bit error of the parallel data output by the receiver is detected by the controller. According to the test result of the bit error, the controller generates the phase adjustment control signal for controlling the phase adjustment module to adjust the phase uniformity of the multiphase clock CLK[0:N-1]. Go into the next step.

(4) Select a clock of the multiphase clock.

(5) Slightly adjust the phase of the clock along the direction of the phase lead till the bit error occurs.

(6) Judge whether the bit error of the parallel data output by the receiver occurs, if it doesn't occur, continue adjusting the phase along the same direction; if it occurs, record the adjusted value of the current phase lead, and go into the next step.

(7) Slightly adjust the phase of the clock along the direction of the phase lag till the bit error occurs again.

(8) Judge whether the bit error of the parallel data output by the receiver occurs, if it doesn't occur, continue adjusting the phase along the same direction; if it occurs, record the adjusted value of the current phase lag.

(9) Take the intermediate value of the adjusted value of the phase lead and the adjusted value of the phase lag as the phase control code of the clock. According to the phase control code, the phase adjustment module adjusts the phase of the clock such that the clock has the best sampling phase relative to the data.

(10) Judge whether the phase adjustment control of the multiphase clock is completed. If it is completed, the self-correcting of the phase uniformity of the multiphase clock is completed, the system goes into the normal operating mode. If it is not completed, correct the next clock adjacent to the adjusted clock.

Here, the step (5) of adjusting the phase of the clock along the direction of the phase lead and the step (7) of adjusting the phase of the clock along the direction of the phase lag can be interchanged.

The present invention uses the internal self-loopback of the random code, and self-corrects the phase of every clock of the multiphase clock by judging whether the bit error of the parallel data output by the receiver occurs, such that the corrected phase of the multiphase clock is uniform and reaches the best sampling window, thus effectively making up the sampling bit errors caused by the phase nonuniformity of the multiphase clock during the manufacturing process or signal transmission process.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A system for self-correcting a multiphase clock, comprising:
a transmitter;
a receiver connected with said transmitter;
a random code generator connected with said transmitter; and
a controller connecting with said random code generator and said receiver,
wherein said random code generator generates a random code stream, said random code stream is transformed to high-speed serial data by said transmitter, said high-speed serial data are sent into said receiver and transformed to parallel data by said receiver, said parallel data are sent into said controller, said controller stores said random code stream, detects a probability of a bit error of said parallel data output by said receiver, and generates a phase adjustment control signal for adjusting a phase uniformity of the multiphase clock according to a test result of said bit error.

2. The system, as recited in claim 1, wherein said receiver comprises a phase locked loop for generating the multiphase clock, a phase adjustment module connecting with said phase locked loop, and a sampler connecting with said phase adjustment module, wherein the multiphase clock acts on said sampler by said phase adjustment module, and then said high-speed serial data are transformed to said parallel data by sampling, and then said parallel data are sent into said controller.

3. The system, as recited in claim 1, wherein said controller controls said phase adjustment module by judging whether said bit error of said parallel data output by said receiver exists, and said phase adjustment module adjusts said phase uniformity of the multiphase clock according to said phase adjustment control signal output by said controller.

4. The system, as recited in claim 2, wherein said controller controls said phase adjustment module by judging whether said bit error of said parallel data output by said receiver exists, and said phase adjustment module adjusts said phase uniformity of the multiphase clock according to said phase adjustment control signal output by said controller.

5. The system, as recited in claim 2, wherein said phase locked loop is a delay-locked loop.

6. The system, as recited in claim 4, wherein said phase locked loop is a delay-locked loop.

7. A method for self-correcting a phase uniformity of a multiphase clock, comprising the steps of:
(1) selecting a clock of the multiphase clock;
(2) adjusting a phase of the clock along a direction of phase lead;
(3) judging whether a bit error of parallel data output by a receiver occurs through a controller, wherein if it doesn't occur, continue adjusting the phase along the same direction till the bit error occurs, record an adjusted value of the current phase lead and go into the next step; if it occurs, record an adjusted value of the current phase lead and go into the next step;
(4) adjusting a phase of the clock along a direction of phase lag;
(5) judging whether a bit error of parallel data output by a receiver occurs through a controller, wherein if it doesn't occur, continue adjusting the phase along the same direction till the bit error occurs, record an adjusted value of the current phase lag and go into the next step; if it occur, record an adjusted value of the current phase lag and go into the next step; and
(6) taking an intermediate value of the adjusted value of the phase lead and the adjusted value of the phase lag as an adjustment control code of the clock, trimming and outputting the clock.

8. The method, as recited in claim 7, further comprising a step of judging whether the phase adjustment control of the multiphase clock is completed by the controller, wherein if it is completed, go into a normal operating mode; if it is not completed, correct a next clock adjacent to the adjusted clock.

9. The method, as recited in claim 7, further comprising a step of judging whether the system goes into a self-correcting mode of the phase uniformity of the multiphase clock before selecting the clock of the multiphase clock, wherein if it does, begin to correct; if it doesn't, go into the normal operating mode.

10. The method, as recited in claim 8, further comprising a step of judging whether the system goes into a self-correcting mode of the phase uniformity of the multiphase clock before selecting the clock of the multiphase clock, wherein if it does, begin to correct; if it doesn't, go into the normal operating mode.

11. The method, as recited in claim 7, further comprising producing a random code stream by a random code generator, storing the random code stream within the controller, testing a probability of the bit error of the parallel data output by the receiver through the controller, and generating a phase adjustment control signal for adjusting the phase uniformity of the multiphase clock according to a test result by the controller.

12. The method, as recited in claim 10, further comprising producing a random code stream by a random code generator, storing the random code stream within the controller, testing a probability of the bit error of the parallel data output by the receiver through the controller, and generating a phase adjustment control signal for adjusting the phase uniformity of the multiphase clock according to a test result by the controller.

13. The method, as recited in claim 11, wherein the random code stream is transformed to high-speed serial data by a transmitter, the high-speed serial data are sent into the receiver and transformed to parallel data by the receiver, and the parallel data are sent into the controller.

14. The method, as recited in claim 12, wherein the random code stream is transformed to high-speed serial data by a transmitter, the high-speed serial data are sent into the receiver and transformed to parallel data by the receiver, and the parallel data are sent into the controller.

15. The method, as recited in claim 7, wherein step (2) of adjusting a phase of the clock along a direction of phase lead and step (4) of adjusting a phase of the clock along a direction of phase lag can be interchanged.

16. The method, as recited in claim 8, wherein step (2) of adjusting a phase of the clock along a direction of phase lead and step (4) of adjusting a phase of the clock along a direction of phase lag can be interchanged.

17. The method, as recited in claim 9, wherein step (2) of adjusting a phase of the clock along a direction of phase lead and step (4) of adjusting a phase of the clock along a direction of phase lag can be interchanged.

18. The method, as recited in claim 10, wherein step (2) of adjusting a phase of the clock along a direction of phase lead and step (4) of adjusting a phase of the clock along a direction of phase lag can be interchanged.

19. The method, as recited in claim 7, wherein the receiver comprises a phase locked loop for generating the multiphase clock, a phase adjustment module connecting with the phase locked loop, and a sampler connecting with the phase adjustment module, wherein the multiphase clock acts on the sampler by the phase adjustment module, and then the high-speed serial data are transformed to the parallel data by sampling, and then the parallel data are sent into the controller.

20. The method, as recited in claim 19, wherein the phase locked loop is a delay-locked loop.
